(19) United States
(12) Patent Application Publication
(10) Pub. No.: US 2009/0157842 A1
(43) Pub. Date: Jun. 18, 2009

(54) System and Method for Using an Aggregation Server with Client Devices

(75) Inventors: Shmuel Shaffer, Palo Alto, CA (US); Ramanathan T. Jagadeesan, San Jose, CA (US); Bich Tu Nguyen, Los Altos, CA (US); Gregory D. Pelton, Raleigh, NC (US); Labhesh Patel, San Francisco, CA (US)

Correspondence Address: BAKER BOTTS L.L.P., 2001 ROSS AVENUE, SUITE 600, DALLAS, TX, 75201-2980, US

(73) Assignee: Cisco Technology, Inc., San Jose, CA (US)

(21) Appl. No.: 11/958,076

(22) Filed: Dec. 17, 2007

(51) Int. Cl. G06F 15/16

(52) U.S. Cl. 709/217

(57) ABSTRACT

In one embodiment, a system includes one or more client devices and a server. The client devices store media files and communicate selection information to the server. The server receives the selection information from the one or more client devices, selects media files for a playlist using the selection information, and generates a playlist of the selected media files.

### TECHNICAL FIELD

The present disclosure relates generally to the field of communications.

### BACKGROUND

A media player is hardware and/or software used to play video, audio, or other media. Many media players support an array of media formats, including audio and video files. Some media players focus only on audio or video and are known as audio players and video players, respectively. For example, audio music players play music in the form of MP3, WAV, AAC, or other file formats, and video players play movies, television shows, or other videos stored in MPEG, AVI, RealVideo, QuickTime, or other file formats. Some media players play both audio and video.

### BRIEF DESCRIPTION OF THE DRAWINGS

FIG. 1 illustrates an example of a system for using an aggregation server with client devices;

FIG. 2 illustrates an example client device for use with an aggregation server;

FIG. 3 illustrates an example aggregation server for use with client devices;

FIG. 4 illustrates an example of table of media file information; and

FIG. 5 illustrates an example method of generating and playing a playlist using an aggregation server with client devices.

### DESCRIPTION OF EXAMPLE EMBODIMENTS

### Overview

In one embodiment, an aggregation server includes a network interface and a server processing module. The network interface communicates with one or more client devices. The server processing module receives selection information from the one or more client devices and uses the selection information to generate a playlist identifying one or more media files.

In another embodiment, a system includes one or more client devices and a server. The client devices store media files and communicate selection information to the server. The server receives the selection information from the one or more client devices, selects media files for a playlist using the selection information, and generates a playlist of the selected media files.

### DESCRIPTION

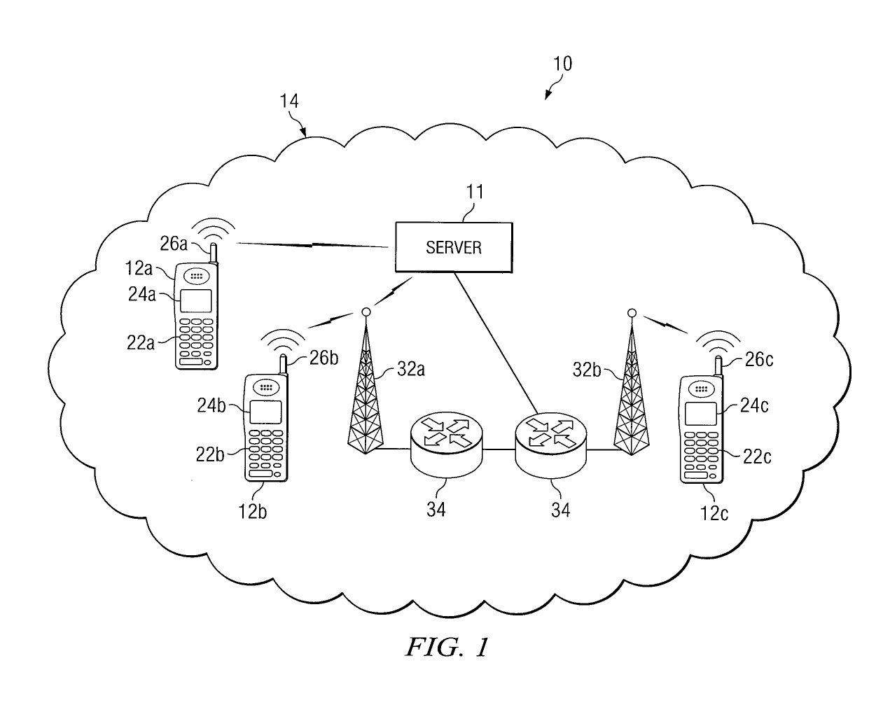

FIG. 1 illustrates an example of a system 10 for using an aggregation server 11 with client devices 12a, 12b, and 12c (generally, client devices 12). Within network 14, aggregation server 11 may communicate with client devices 12 to generate a playlist of media files.

Aggregation server 11 may be any combination of hardware and software capable of receiving selection information from client devices 12 and using the selection information to generate a playlist of media files. In a particular embodiment, aggregation server 11 is a computer programmed with software to generate a playlist of media files based on selection information received from client devices 12.

Aggregation server 11 may communicate with client devices 12 using any combination of WiFi, Bluetooth, or other wireless or wireline technologies. In a particular embodiment, aggregation server 11 may communicate directly with client devices 12 without an intervening network device. For example, as illustrated in FIG. 1, aggregation server 11 communicates directly with client device 12a using wireless technology. In an alternative embodiment, aggregation server 11 communicates with client devices 12 using one or more external bridges, routers, switches, or other network devices. For example, in the illustrated embodiment, aggregation server 11 communicates with client device 12b using base stations 32a, and aggregation server 11 communicates with client device 12c using router 34 and base stations 32b.

Client devices 12 may be any combination of hardware and software used to play audio, video, or other media files. In a particular embodiment, client device 12a is an audio music player capably of playing MP3, WAV, AAC, or other audio file formats. In an alternative embodiment, client device 12b is a video player capable of playing MPEG, AVI, RealVideo, QuickTime, or other video file formats. In yet another alternative embodiment, client device 12c is a media player capably of playing both audio and video files.

Client device 12 may be mobile. For example, in a particular embodiment, client device 12a may be an MP3 or other audio player, such as an Apple iPod. In an alternative embodiment, client device 12b may be a laptop or notebook computer. In another particular embodiment, client device 12c may be a mobile telephone. Those skilled in the art will recognize that client devices 12 may combine the functionality of playing voice, video, or any other media with mobile phone capabilities.

Client devices 12 include input interfaces 22a, 22b, and 22c (generally, input interfaces 22), output interfaces 24a, 24b, and 24c (generally, output interfaces 24), and network interfaces 26a, 26b, and 26c (generally, network interfaces 26). Input interfaces 22 may include a number pad, alpha-numeric keyboard, rolling ball, touch-screen, scroll wheel, or any other combination of hardware and/or software for receiving input information from a user. In one example embodiment, input interface 22 may be a microphone which may be associated with speech recognition functionality. Output interfaces 24 may include an LCD, speakers, monitor, screen, or any other combination of hardware and/or software for communicating output information to a user. Network interfaces 26 may include a network card, antenna, Bluetooth, or any other combination of hardware and/or software for communicating information to or from other client devices 12 or other network devices.

Client devices 12 communicate selection information to aggregation server 11, and aggregation server 11 uses the selection information to generate a playlist of media files. Client devices 12 may communicate selection information relating to one or more media files stored on client devices 12, and aggregation server 11 generates a playlist of media files. In a particular embodiment, aggregation server 11 may request selection information from client devices 12, and in response, client devices 12 may communicate selection information to aggregation server 11. For example, aggregations server 11 may detect client devices 12 and request selection information from client devices 12 in response to detecting client devices 12. Alternatively, users of client devices 12 may instruct client devices to communicate selection information to aggregation server 11.

Aggregation server 11 may generate the playlist from media files stored in client devices 12, from media files stored by aggregation server 11, or from both media files stored in client devices 12 and media files stored by aggregation server 11. In a particular embodiment, aggregation server 11 may store media files, and aggregation server 11 may generate a playlist of media files stored by aggregation server 11 based on selection information received from client devices 12. In an alternative embodiment, aggregation server 11 may not store media file, and aggregation server 11 may generate a playlist of media files stored on client devices 12. In yet another embodiment, aggregation server 11 may store media files, and aggregation server 11 may generate a playlist of both media files stored by aggregation server 11 and media files stored on client devices 12.

In a particular mode of operation, client devices 12 may communicate selection information identifying at least some of the media files stored in client devices 12, and in response aggregation server 11 may generate a playlist including identified media files stored in client devices 12. In a particular embodiment, aggregation server 11 selects media files stored in the most number of client devices 12. As a result, the playlist may comprise common media files stored in several client devices 12. In an alternative embodiment, aggregation server 11 may generate a playlist from a combination of media files stored in client device 12a, media files stored in client device 12b, and media files stored in client device 12c, including media files that are not common to client devices 12a, 12b, and 12c.

In another mode of operation, client devices 12 may communicate selection information indicating a genre of media, and aggregation server 11 may generate a playlist from media files associated with the genre. A genre may be any suitable category, type, or description used to classify media into groups. For example, in particular embodiment, genres associated with audio music files may include rock, jazz, world, rap, pop, country, classical, or any other suitable category of music. In a particular embodiment, aggregation server 11 receives from one or more other client devices 12 selection information indicating one or more genres that the users of client devices 12 like, and aggregation server 11 selects one or more common genres liked by the users of client devices 12. Each client device 12 may determine which genres a user likes based either on user input or on the genres associated with the media files stored in client device 12. In an alternative embodiment, aggregation server 11 receives from one or more other client devices 12 selection information indicating one or more genres that the user of client devices 12b and 12c dislike, and aggregation server 11 selects one more genres, excluding the genres disliked by the users of client devices 12b and 12c. Aggregation server 11 may identify media files associated with the selected genres and generate a playlist from the identified media files associated with the selected genres.

In another mode of operation, client devices 12 may communicate selection information including rating information, and aggregation server 11 may generate a playlist from media files according to the rating information. In a particular embodiment, the rating information indicates how much a user likes or dislikes various media files stored on client device 12. In such an embodiment, the rating information may be a rating on a fixed scale, such as, for example, a number scale from 1 to 5 with a 1 indicating that user dislikes a file and a 5 indicating that the user likes the file. In a particular embodiment, client devices 12 communicate to aggregation server 11 rating information identifying a number of media files that are highly rated, and aggregation server 11 generates a playlist from the media files identified by the rating information. Aggregation server 11 may select media files for the playlist based on the rating information from more than one client device 12. For example, aggregation server 11 may receive rating information from more than one client device 12 and may select media files that are also highly rated in more than one client device 12.

In another mode of operation, client devices 12 may communicate selection information including usage information, and aggregation server 11 may generate a playlist from media files according to the usage information. In a particular embodiment, the usage information indicates how frequently client device 12 has played media files stored on client device 12. For example, in an audio player, the usage information may indicate the number of times a user has played each of several audio files. In a particular embodiment, client device 12 communicates to aggregation server 11 usage information identifying a number of media files that client device 12 has played the most number of times, and aggregation server 11 generates a playlist from the media files identified by the usage information. Aggregation server 11 may select media files for the playlist based on usage information from more than one client device 12. For example, aggregation server 11 may receive usage information from more than one client device 12 and may select media files that have been played a relatively large number of times by more than one client device 12.

After generating the playlist, aggregation server 11 may play media files from the playlist. In a particular embodiment, aggregation server 11 may play media files in a manner accessible to user of client devices 12. For example, aggregation server 11 may generate a playlist of audio files and then play the audio files over a speaker system such that users of client devices may hear the audio files. In such an embodiment, several users may enter a building, room, or other facility, and aggregation server 11 may generate a playlist of media files that the users like, and then play the media files for the user's common enjoyment.

After generating the playlist, aggregation server 11 may communicate the playlist to client devices 12 so that that client devices 12 may play media files from the playlist. In a particular embodiment, aggregation server 11 communicates identifiers identifying each of the media files included in the playlist. In an alternative embodiment, client device 12a communicates the media files included in the playlist.

Client devices 12 may play the media files included in the playlist. In a particular embodiment, each client device 12 may separately play the media files. In an alternative embodiment, aggregation server 11 may communicate synchronization information to two or more client devices 12 to synchronize playback of the media files. For example, in a particular embodiment, aggregation server 11 may communicate synchronization information indicating the point in the media files of a playlist that client devices 12 should be playing at a particular point in time. Using the synchronization information, client devices 12 may adjust their playing of the media files such that client devices 12 are playing substantially the same portion of the media files of a playlist at substantially the same time. In a particular embodiment, aggregation server 11 may communicate the synchronization information at the beginning of the playing of each media file. In an alternative embodiment, aggregation server 11 communicates synchronization information to client devices 12 at periodic intervals, such as at fixed intervals of time. Alternatively, client devices 12 may communicate synchronization information to one another to confirm that their playback is synchronized.

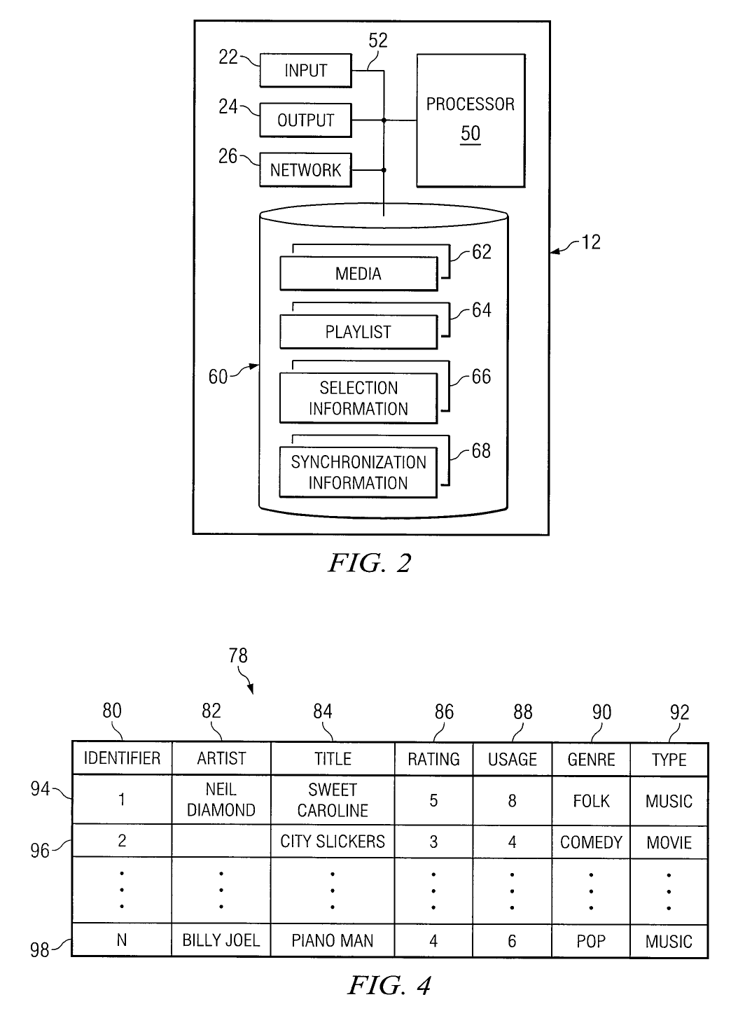

FIG. 2 illustrates an example client device 12 for use with aggregation server 11. As described above, client device 12 communicates with aggregation server 11 to generate playlists 64 and to play media files 62 from playlists 64. Client device 12 includes input interface 22, output interface 24, network interface 26, processor 50, and memory 60.

Memory 60 stores media files 62, playlists 64, selection information 66, and synchronization information 68. Memory 60 may include any combination of volatile and non-volatile memory. In a particular embodiment, memory 60 may include flash memory. In an alternative embodiment, memory 60 includes a hard drive.

Media files 62 may include audio files, video files, photos, images, or any other suitable combination of audio and/or visual information. In a particular embodiment, media files 62 include MP3, WAV, AAC, or other audio files. In an alternative embodiment, media files 62 include MPEG, AVI, RealVideo, QuickTime, or other video files. Media files 62 may include or be associated with descriptive or identifying text relating to the audio, video, or other content of media files 62.

Playlist 64 represents a group of one or more media files 62 associated together as a group. In a particular embodiment, playlist 64 may be a list or other data structure including identifiers associated with one or more media files 62. Playlist 64 may include or be associated with descriptive or identifying text relating to playlist 64 and/or media files 62 included in playlist 64.

Selection information 66 is information used to generate playlists 64. Selection information may relate to media files 62 stored in memory 60 or may relate to media files 62 stored in other client devices 12 or other devices. As explained above, client device 12 may communicate selection information 66 to aggregation server 11. In a particular embodiment, selection information 66 identifies one or more media files 62 stored in memory 60 of client device 12. In an alternative embodiment, selection information 66 may identify one or more genres that a user of client device 12 either likes or dislikes. In another embodiment, selection information 66 may include rating information indicating how much a user of client device 12 likes or dislikes various media files 62. In another embodiment, selection information 66 may include usage information indicating how frequently or how many times client device 12 has played media files 62. Selection information 66 may include any combination of media file identification information, genre information, rating information, usage information, or any other suitable information that may be used to generate playlist 64.

Synchronization information 68 is information used by client devices 12 to synchronize their playing of media files 62. Synchronization information 68 may be received from aggregation server 11 or other client devices 12. In a particular embodiment, synchronization information 68 is used to indicate to the portion of media files 62 of playlist 64 that processor 50 should be playing at a particular point in time. For example, synchronization information 68 may identify a particular part of media file 62, such as the beginning of media file 62, that client device 12 should play at a particular point in time, and client device 12 plays that portion of media file 62 at the particular point in time. In an alternative embodiment, synchronization information 68 may identify periodic intervals in media files 62 or playlists 64, such as every two minutes, every 30 second, or any other suitable interval of time. In an alternative embodiment, client device may periodically receive from aggregation server 11 synchronization information 68 identifying a portion (or position) in one media files 62 of playlist 64, and client device 12 confirms that it is playing the identified portion of media files 62 when it receives the synchronization information 68 or adjust its playback so that it is playing the identified portion of media files 62 when it receives the synchronization information 68. In a particular embodiment, synchronization information 68 is stored together with and associated with media files 62 or playlists 64.

Input interface 22 receives input information from a user. In a particular embodiment, input interface 22 may include a number pad, alpha-numeric keyboard, rolling ball, touch-screen, scroll wheel, or any other combination of hardware and/or software for receiving input information from a user. Input interface 22 may receive input information used to generate selection information 66 relating to media files 62. For example, input information may include ratings relating media files 62, and processor 50 may store the ratings as selection information 66 in memory 60 for later use in generating playlist 64 from media files 62. Alternatively, input information interface 22 may receive input information relating to the functions of client device 12. For example, input information interface 22 may receive user input indicating when to perform start, stop, skip, or other functions relating to the playing of media files 62 or playlists 64. In a particular embodiment, input interface may receive user instruction regarding whether to communicate selection information 66 to aggregation server 11.

Output interface 24 communicates output information to a user. In a particular embodiment, output interface 24 may include an LCD, speakers, monitor, screen, or any other combination of hardware and/or software for communicating output information to a user. For example, output interface 24 may include an LCD, monitor, screen, or other visual interface for communicating textual information about playlist 64, media file 62, functions of client device 12, communications with other client devices 12, and/or status of client device 12. In addition, output interface 24 may include speakers, headphone jack, headphones, or other audio, video, or visual interfaces for communicating audio, video, or other related media information from media files 62.

Network interface 26 supports communications with aggregation server 11 and, possibly, other client devices 12. In a particular embodiment, network interface 26 may include a network card, antenna, Bluetooth, or any other combination of hardware and/or software for communicating information to or from aggregation server 11 and, possibly, other client devices 12, base stations 32, or other network devices 34. Network interface 26 may communicate with aggregation server 11 or other client device 12 using WiFi, Bluetooth, or other wireless or wireline technologies. In a particular embodiment, network interface 26 may communicate directly with aggregation server 11 or another client device 12 without an intervening network device. In an alternative embodiment, network interface 26 may communicate with aggregation server 11 or another client device 12 using one or more base stations 32, external bridges, routers, switches, or other network devices 34.

Processor 50 controls the operations of client device 12, including communications with aggregation server 11 and the playing of media files 62 from playlists 64. In a particular embodiment, processor 50 may include any suitable combination of hardware and/or software. Processor 50 may receive input information from a user using input interface 22 and communicate output information to a user using output interface 24. Processor 50 may communicate media files 62, playlists 64, selection information 66, synchronization information 68, or other suitable information with aggregation server 11 using network interface 26. Processor 50 may store media files 62, playlists 64, selection information 66, synchronization information 68, or other suitable information in memory 60. Processor 50 may communicate with input interface 22, output interface 24, network interface 26, and memory 60 using any suitable combination of shared and/or dedicated communication paths. In a particular embodiment, processor 50 communicates with input interface 22, output interface 24, network interface 26, and memory 60 using a bus 52.

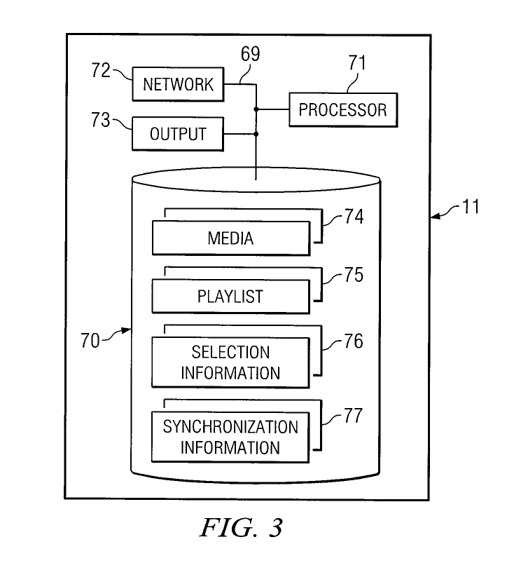

FIG. 3 illustrates an example aggregation server 11 for use with client devices 12. As described above, aggregation server 11 receives selection information 76 from one or more client devices 12 and generates a playlist 75 of media files 62 or 74 using selection information 76. Aggregation server 11 includes memory 70, processor 71, network interface 72, and output interface 73.

Memory 70 stores information used by aggregation server 11 to generate playlists 75. Memory 70 stores media files 74, playlists 75, selection information 76, and synchronization information 77. Memory 70 may include any combination of volatile and non-volatile memory. In a particular embodiment, memory 70 may include flash memory. In an alternative embodiment, memory 70 includes a hard drive. In the illustrated embodiment, memory 70 is internal to aggregation server 11. In an alternative embodiment, memory 70 may be external from aggregation server 11, such as an external database, external hard drive, or external server. In yet another embodiment, memory 70 may include memory internal to aggregation server 11 and memory external from aggregation server 11.

Media files 74 may include audio files, video files, photos, images, or any other suitable combination of audio and/or visual information. In a particular embodiment, media files 74 include MP3, WAV, AAC, or other audio files. In an alternative embodiment, media files 74 include MPEG, AVI, RealVideo, QuickTime, or other video files. Media files 74 may include or be associated with descriptive or identifying text relating to the audio, video, or other content of media files 74.

Playlist 75 represents a group of one or more media files 62 or 74 associated together as a group. In a particular embodiment, playlist 75 may be a list or other data structure including identifiers associated with one or more media files 62 or 74. In a particular embodiment, aggregation server 11 generates playlists 75 of media files 74 stored in memory 70 of aggregation server 11. In an alternative embodiment, aggregation server 11 generates playlists 75 of media files 62 stored in client devices 12. In such an embodiment, aggregation server 11 may not store media files 74. In yet another embodiment, aggregation server 11 generates playlists 75 of media files 74 stored in memory 70 and media files 62 stored in client devices 12. Playlist 75 may include or be associated with descriptive or identifying text relating to playlist 75 and/or media files 62 or 74 included in playlist 75.

Selection information 76 is information used to generate playlists 75. Selection information 76 may relate to media files 74 stored in memory 70 or may relate to media files 62 stored in client devices 12 or other devices. As explained above, client device 12 may communicate selection information 66 to aggregation server 11. Aggregation server 11 may receive selection information 66 from client device 12 and store it as selection information 76 in memory 70. In a particular embodiment, selection information 76 identifies one or more media files 62 stored on one or more client devices 12. In an alternative embodiment, selection information 76 may identify one or more genres that a user of client device 12 either likes or dislikes. In another embodiment, selection information 76 may include rating information indicating how much a user of client device 12 likes or dislikes various media files 62. In another embodiment, selection information 76 may include usage information indicating how frequently or how many times client device has played media files 62. Selection information 76 may include any combination of media file identification information, genre information, rating information, usage information, or any other suitable information that may be used to generate playlist 64.

Synchronization information 77 is information that aggregation server 11 may communicate to client devices 12 to synchronize their playing of media files 62. In a particular embodiment, synchronization information 77 is used to indicate to client devices 12 the point in media files 62 of playlist 64 that each client device 12 should be playing at a particular point in time. For example, synchronization information 77 may identify a particular part of media file 62, such as the beginning of media file 62. In an alternative embodiment, synchronization information 77 may identify periodic intervals in media files 62 or playlists 64 or 75, such as every two minutes, every 30 second, or any other suitable interval of time. In an alternative embodiment, aggregation server 11 may periodically communicate synchronization information 77 identifying a portion (or position) in one media files 62 of playlist 64 or 75, and client device 12 confirms that it is playing the identified portion of media files 62 when it receives the synchronization information 77 or adjust its playback so that it is playing the identified portion of media files 62 when it receives the synchronization information 77. In a particular embodiment, synchronization information 77 is stored together with and associated with media files 62 or playlists 64 or 75.

Processor 71 controls the operations of aggregation server 11, including communicating with client devices 12, generating playlists 75, and playing of media files 62 or 74 from playlists 75. In a particular embodiment, processor 71 may include any suitable combination of hardware and/or software. Processor 71 may communicate output information to a user using output interface 73. Processor 71 may communicate media files 74, playlists 75, synchronization information 77, or other suitable information with client devices 12 using network interface 72. Processor 71 may store media files 74, playlists 75, selection information 76, synchronization information 77, or other suitable information in memory 70. Processor 71 may communicate with memory 70, network interface 72, and output interface 73 using any suitable combination of shared and/or dedicated communication paths. In a particular embodiment, processor 71 communicates with memory 70, network interface 72, and output interface 73 using a bus 69.

Network interface 72 supports communications with one or more client devices 12. In a particular embodiment, network interface 72 may include a network card, antenna, Bluetooth, or any other combination of hardware and/or software for communicating information to or from client devices 12, base stations 32, or other network devices 34. Network interface 26 may communicate with client device 12 using WiFi, Bluetooth, or other wireless or wireline technologies. In a particular embodiment, network interface 26 may communicate directly to client device 12 without an intervening network device. In an alternative embodiment, network interface 26 may communicate with client device 12 using one or more base stations 32, external bridges, routers, switches, or other network devices 34.

Output interface 73 communicates output information to a user. In a particular embodiment, output interface 73 may include an LCD, speakers, monitor, screen, or any other combination of hardware and/or software for communicating output information to a user. For example, output interface 73 may include an LCD, monitor, screen, or other visual interface for communicating textual information about playlist 75, media file 74, functions of aggregation server 11, communications with client devices 12, and/or status of aggregation server 11. In addition, output interface 73 may include speakers, headphone jack, headphones, or other audio, video, or visual interfaces for communicating audio, video, or other media information from media files 74. In a particular embodiment, output interface 73 may include a speaker system or an interface to a speaker system. In such an embodiment, users may enter an area (such as a building, room or other facility), and aggregation server 11 receives selection information 76 from the users' client devices 12, generates playlist 75 from selection information 76, and plays media files 74 from playlist 75 over a speaker system so that the users may hear media files 74 selected based on selection information 76 from their client devices 12.

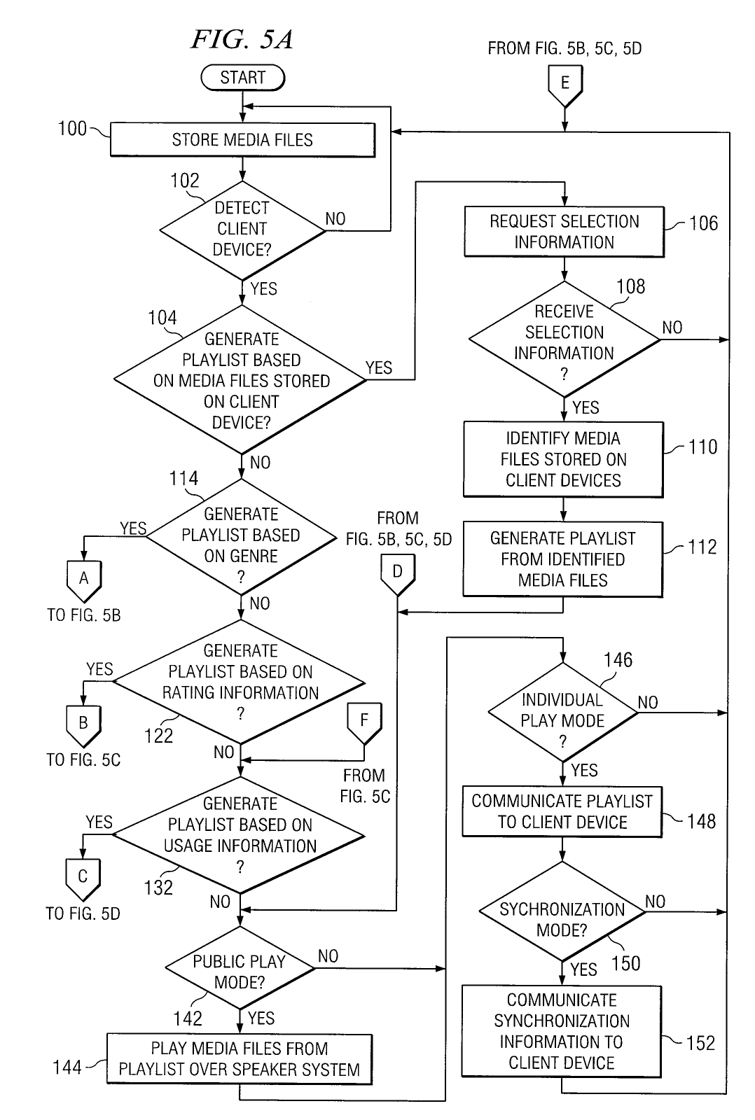

FIG. 4 illustrates an example of table 78 of media file information, which may be stored in memory 60 of client devices 12 or in memory 70 of aggregation server 11. Table 78 may include selection information 66 or 76. Aggregation server 11 and client device 12 may use table 78 or any other suitable data structure to store information about media files 62 or 74. Aggregation server 11 may use the media file information in table 78 to generate playlist 75.

Column 80 of table 78 includes a identifier for medias file 62 or 74. In the particular illustrated embodiment, the identifiers in column 80 are numbers. In alternative embodiment, the identifier may be a data address, a pointer, an alpha-numeric label, or any other designation suitable for identifying media files 62 or 74.

Column 82 of table 78 lists the artist associated with each media file 62 or 74. Some media files 62 or 74, like the songs in rows 94 and 98, may be associated with a single artist. Other media files 62 or 74, such as the movie in row 96, may be associated with no artist. Other media files 62 or 74 may be associated with several artists.

Column 84 lists the title of each media file 62 or 74. The title may be a string of characters that can be output to the user to identify each media file 62 or 74.

Column 86 includes rating information associated with each media file 62 or 74. In a particular embodiment, the rating information may be a number indicating how much a user likes or dislikes each media file 62 or 74. In an alternative embodiment, the rating information in column 86 may be a description of the user's assessment of each media 62 or 74. In another alternative embodiment, the rating may be a symbol or collection of symbols, such as a number of stars.

In a particular embodiment, aggregation server 11 may use the rating information in column 86 as selection information 76 to be used to generate playlist 75. For example, aggregation server 11 may use the rating information to select highly rated media files 62 or 74. In such an embodiment, aggregation server 11 may receive rating information from client devices 12 and may generate playlist 75 based on rating information from client devices 12. In a particular embodiment, client device 12 may communicate the rating information to aggregation server 11 as selection information 76 to be used to generate playlist 75. Alternatively, client device 12 may select media files 62 based on the rating information and then communicate selection information 66 identifying the selected media files 62 to aggregation server 11.

Column 88 includes usage information associated with each media file 62. In a particular embodiment, column 88 may indicate the number of times one or more users have started playing or finished playing each media file 62. In an alternative embodiment, the usage information in column 88 may indicate the amount of time the user has spent playing each media file 62. In another alternative embodiment, the usage information may be any designation suitable for comparing or contrasting the amount of time client device 12 has played each media file 62 relative to other media files 62 in memory 60.

In a particular embodiment, aggregation server 11 may use the usage information in column 88 as selection information 76 to generate playlist 75. For example, aggregation server 11 may use the usage information to select media files 62 played more often than other media files 62. In such an embodiment, client device 12 may communicate the usage information to aggregation server 11 as selection information 76, and aggregation server 11 may use the usage information to select media files 62 or 74 to include in playlist 75. Alternatively, client device 12 may use the usage information to select media files 62 and then communicate selection information 66 identifying the selected media files 62 to aggregation server 11.

Column 90 includes a genre associated with each media file 62 or 74. In a particular embodiment, each media file 62 or 74 may be associated with a single genre. In an alternative embodiment, each media file 62 or 74 may be associated with more than one genre.

In a particular embodiment, aggregation server 11 may use the genre information in column 90 as selection information 76 to generate playlist 75. For example, client device 12 may receive user input selecting a particular genre and communicate the genre information as selection information 76 to aggregation server 11, and aggregation server 11 may use the genre information to select media files 63 or 74 to include in playlist 75. Alternatively, client device 12 may use the genre information to select media files 62 and then communicate selection information 66 identifying the selected media files 62 to aggregation server 11.

Column 92 associates each media file 62 or 74 with a type of file. For example, media file number 1 in row 94 is identified as a music file, and media file number 2 in row 96 is identified as a movie file.

Table 78 is an example illustrating that type of information that client devices 12 and aggregation server 11 may use to generate playlist 75. In alternative embodiments, client devices 12 and aggregation server 11 may use other types of selection information 76 to generate playlist 64.

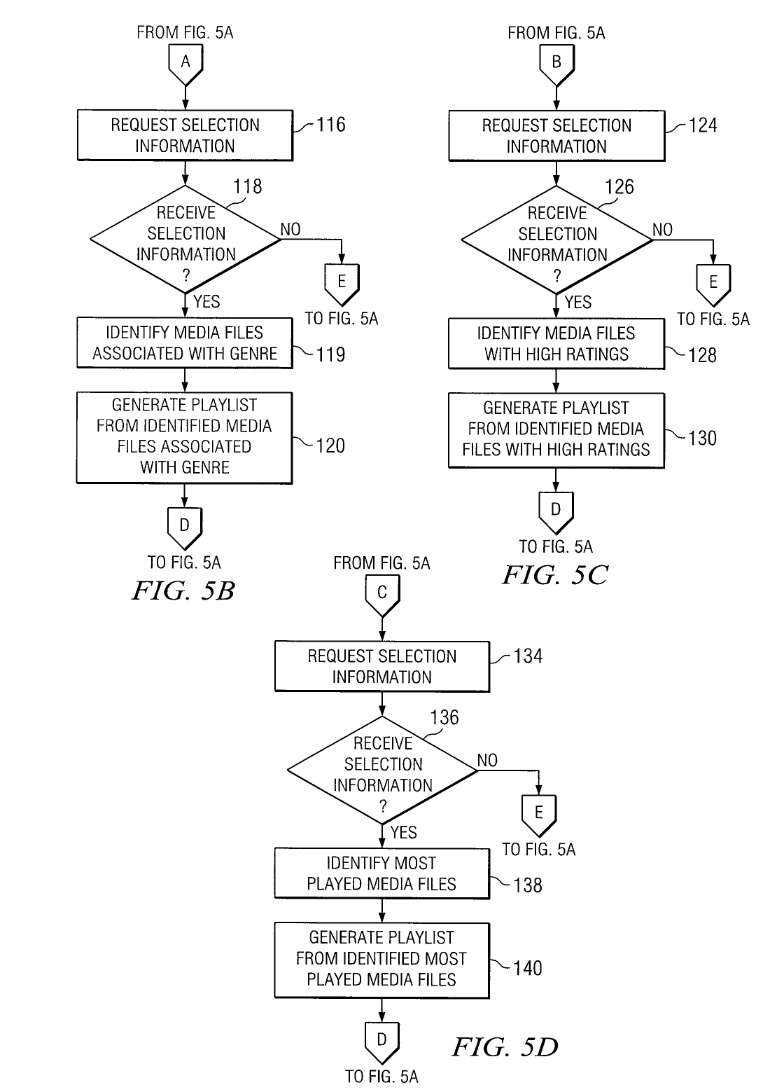

FIG. 5 illustrates an example method of generating and playing playlist 75 using aggregation server 11 with client devices 12. The method begins at step 100, where aggregation server 11 stores media files 74 in memory 70. In an alternative embodiment, aggregation server 11 may not store media files 74 in memory 70 but instead rely on media files 62 stored in memories 60 of client devices 12.

At step 102, aggregation server 11 may detect one or more client devices 12 using network interface 72. If aggregation server 11 does not detect client devices 12 at step 102, aggregation server 11 continues to store media files 74 in memory 70 at step 100 until it detects client device 12. If aggregation server 11 detects client device 12 at step 102, the method continues at steps 104, 114, 122, and 132, where aggregation server 11 may generate playlist 75 in any of several different ways depending on the mode of operation of aggregation server 11.

If, at step 104, aggregation server 11 is set in a mode of operation to generate playlist 75 based on media files 62 stored on client devices 12, aggregation server 11 requests selection information 66 from client device 12 at step 106. If aggregation server 11 receives selection information 66 at step 108, aggregation server 11 uses selection information 66 to identify media files 62 stored on client device 12 at step 110 and to generate playlist 75 from identified media files 62 at step 112. In a particular embodiment, selection information 66 identifies media files 62 stored on client device 12. The method continues at step 142.

If aggregation server 11 does not receive selection information 66 at step 108, then the method returns to step 100, where aggregation server 11 continues to store media files 74 in memory 70 until it detects client device 12. In a particular embodiment, client device 12 may have to receive user permission before sharing selection information 66 with aggregation server 11. In such an embodiment, aggregation server 11 may not receive selection information 66 from client device 12 if the user of client device 12 elects not to share selection information 66 with aggregation server 11.

If aggregation server 11 is not set in a mode of operation to generate playlist 75 based on media files 62 stored on client devices 12 at step 104, aggregation server 11 may be set in a mode of operation to generate playlist 75 based on genre at step 114. If, at step 114, aggregation server 11 is set up to generate playlist 75 based on genre, aggregation server 11 requests selection information 66 from client device 12 at step 116. If aggregation server 11 receives selection information 66 at step 118, aggregation server 11 identifies media files 62 or 74 associated with the genres indicated by selection information 66 at step 119 and generates playlist 75 from identified media files 62 or 74 associated with the genres. In a particular embodiment, aggregation server 11 receives from one or more other client devices 12 selection information 66 indicating one or more genres that the users of client devices 12 like. The method continues at step 142.

If aggregation server 11 does not receive selection information 66 at step 118, then the method returns to step 100, where aggregation server 11 continues to store media files 74 in memory 70 until it detects client device 12. In a particular embodiment, client device 12 may have to receive user permission before sharing selection information 66 with aggregation server 11. In such an embodiment, aggregation server 11 may not receive selection information 66 from client device 12 if the user of client device 12 elects not to share selection information 66 with aggregation server 11.

If aggregation server 11 is not set in a mode of operation to generate playlist 75 based on genre at step 114, aggregation server 11 may be set in a mode of operation to generate playlist 75 based on rating information at step 122. If, at step 122, aggregation server 11 is set up to generate playlist 75 based on rating information, aggregation server 11 requests selection information 66 from client device 12 at step 124. If aggregation server 11 receives selection information 66 at step 126, aggregation server 11 identifies media files 62 or 74 with high ratings at step 128 and generates playlist 75 from identified media files 62 or 74 with high ratings at step 130. In a particular embodiment, client device 12 receives rating information indicating one or more media files 62 the user of client device 12 likes. The method continues at step 142.

If aggregation server 11 does not receive selection information 66 at step 126, then the method returns to step 100, where aggregation server 11 continues to store media files 74 in memory 70 until it detects client device 12. In a particular embodiment, client device 12 may have to receive user permission before sharing selection information 66 with aggregation server 11. In such an embodiment, aggregation server 11 may not receive selection information 66 from client device 12 if the user of client device 12 elects not to share selection information 66 with aggregation server 11.

If aggregation server 11 is not set in a mode of operation to generate playlist 75 based on rating information at step 122, aggregation server 11 may be set in a mode of operation to generate playlist 75 based on usage information at step 132. If, at step 132, aggregation server 11 is set up to generate playlist 75 based on usage information, aggregation server 11 requests selection information 66 from client device 12 at step 134. If aggregation server 11 receives selection information 66 at step 136, aggregation server 11 identifies media files 62 played most often using selection information 66 at step 138 and generates playlist 64 from identified most played media files 62 at step 140. In a particular embodiment, aggregation server 11 receives from one or more other client devices 12 usage information indicating one or more media files 62 the users of client devices 12 play most often. The method continues at step 142.

If aggregation server 11 does not receive selection information 66 at step 136, then the method returns to step 100, where aggregation server 11 continues to store media files 74 in memory 70 until it detects client device 12. In a particular embodiment, client device 12 may have to receive user permission before sharing selection information 66 with aggregation server 11. In such an embodiment, aggregation server 11 may not receive selection information 66 from client device 12 if the user of client device 12 elects not to share selection information 66 with aggregation server 11.

At step 142, aggregation server 11 may be in public play mode. If aggregation server 11 is in public play mode at step 142, aggregation server 11 may play media files 74 from playlist 75 using output interface 73 of aggregation server 11. In such an embodiment, aggregation server 11 may play media files 74 over a speaker system in a room, building, facility, or other location. The method continues at step 146.

At step 146, aggregation server 11 may be in individual play mode. If aggregation server 11 is in individual play mode at step 146, aggregation server 11 may communicate playlist 75 so that individual users may play media files 62 from playlist 64 stored in memory 60 of client device 12. If aggregation server 11 is in individual play mode at step 146, synchronization server 11 communicates playlist 75 to client devices 12 at step 148; otherwise the method returns to step 100, where aggregation server 11 continues to store media files 74 in memory 70 until it detects client device 12.

At step 150, aggregation server 11 may be in synchronization mode. In this particular embodiment, synchronization mode is a particular type of individual play mode in which aggregation server 11 assists in synchronizing the playing of media files 62 on multiple client devices 12. If aggregation server 11 is in synchronization mode at step 150, aggregation server 11 communicates synchronization information 77 to client devices at step 152. In particular embodiment, aggregation server 11 may communicate synchronization information 77 only to initiate the playing of media files 62 on client devices 12. In alternative embodiment, aggregation server 11 may communicate synchronization information 77 when each client device 12 should state playing each media file 62 from playlist 64. In yet another embodiment, aggregation server 11 may communicate synchronization information 77 during the playing of media files 62, for example at periodic intervals. The method returns to step 100, where aggregation server 11 continues to store media files 74 in memory 70 until it detects client device 12.

The present disclosure encompasses all changes, substitutions, variations, alterations, and modifications to the example embodiments described herein that a person having ordinary skill in the art would comprehend. Similarly, where appropriate, the appended claims encompass all changes, substitutions, variations, alterations, and modifications to the example embodiments described herein that a person having ordinary skill in the art would comprehend.

What is claimed is:

1. An aggregation server, comprising:
a network interface operable to communicate with one or more client devices; and
a server processing module operable to receive selection information from the one or more client devices and to use the selection information to generate a playlist identifying one or more media files.

2. The aggregation server of claim 1, wherein:
the selection information identifies media files stored on at least one of the client devices and
the server processing module is operable to generate the playlist including at least some of the identified media files.

3. The aggregation server of claim 1, wherein:
the selection information comprises a genre; and
the server processing module is operable to identify media files associated with the genre and to generate the playlist from the identified media files associated with the genre.

4. The aggregation server of claim 1, wherein:
the selection information comprises rating information relating to media files stored by at least one of the client devices; and
the server processing module is operable to generate the playlist from at least some media files that are highly rated according to the rating information.

5. The aggregation server of claim 1, wherein the server processing module is further operable to play media files from the playlist.

6. The aggregation server of claim 1, wherein the server processing module is further operable to synchronize on at least some of the client devices playback of the media files from the playlist.

7. A system, comprising:
one or more client devices operable to store media files and to communicate selection information relating to the media files;
a server operable to receive the selection information from the one or more client devices, to select media files for a playlist using the selection information, and to generate a playlist of the selected media files.

8. The system of claim 7, wherein:
at least one client device is operable to communicate a list identifying media files stored on the client device; and
the server is further operable to receive the list and to select for the playlist at least some of the media files that are identified on the list.

9. The system of claim 7, wherein:
at least one client device is operable to communicate selection information comprising a genre of media; and
the server is further operable to select for the playlist at least some media files associated with the genre.

10. The system of claim 7, wherein:
at least one client device is operable to communicate rating information relating to media files stored on the client device; and
the server is further operable to select for the playlist at least some media files that are highly rated according to the rating information.

11. The system of claim 7, wherein:
at least one client device is operable to communicate usage information relating to media files stored on the client device; and
the server is further operable to select for the playlist at least some media files that have been most played according to the usage information.

12. The system of claim 7, wherein the server is further operable to play media files from the playlist.

13. The system of claim 7, wherein the server is further operable to synchronize on the client devices playback of the media files from the playlist.

14. A method for comprising:
receiving at a server first selection information between a first client device;
receiving at the server second selection information for a second client device; and
generating at the server a playlist of media files using the first and second selection information.

15. The method of claim 14, wherein:
the first selection information identifies media files stored on the first client device;
the second selection information identifies media files stored on the second client device; and
generating the playlist using the first and second selection information comprises generating the playlist from common media files that are stored on both the first client device and second client device.

16. The method of claim 14, wherein:
the first and second selection information identifies one or more genres; and
generating the playlist using the first and second selection information comprises generating the playlist from media files associated with the genres.

17. The method of claim 14, wherein:
the first and second selection information comprises rating information from the first client device and the second client device; and
generating the playlist using the first and second selection information comprises generating the playlist to include at least some media files that are highly rated according to the rating information received from the first and second client devices.

18. The method of claim 14, wherein:
the first and second selection information comprises usage information relating to media files stored on the first and second client devices; and
generating the playlist using the selection information comprises generating the playlist based on the usage information.

19. The method of claim 14, further comprising:
playing media files from the playlist over a speaker system.

20. The method of claim 14, further comprising synchronizing in the first client device and second client device playback of the media files from the playlist.

21. An apparatus, comprising:
means for receiving first selection information between a first client device;
means for receiving second selection information for a second client device; and
means for generating a playlist of media files using the first and second selection information.
